(19) United States
(12) Patent Application Publication
(10) Pub. No.: US 2005/0076449 A1
(43) Pub. Date: Apr. 14, 2005

(54) Inflatable article and process for manufacturing the same

(76) Inventor: Hank W.C. Yuan, Taipei City (TW)

Correspondence Address: LADAS & PARRY LLP, 224 SOUTH MICHIGAN AVENUE, SUITE 1200, CHICAGO, IL, 60604, US

(21) Appl. No.: 10/403,957

(22) Filed: Mar. 31, 2003

(30) Foreign Application Priority Data
Jan. 30, 2003 (CN) 03202257.3

(51) Int. Cl. B32B 31/00

(52) U.S. Cl. 5/932; 156/292; 156/308.2

(57) ABSTRACT

In a process for manufacturing an inflatable article, box-like upper and lower mattress bodies of similar dimensions are superimposed upon each other. The upper mattress body includes first upper and lower sheets, and a first interconnecting strip interconnecting peripheral areas of the first upper and lower sheets. The lower mattress body includes second upper and lower sheets, and a second interconnecting strip interconnecting peripheral areas of the second upper and lower sheets. Junctures of the first lower sheet and the second upper sheet are united by heat-sealing so as to form a surrounding clearance between the junctures and peripheries of the sheets for retaining a bedcover.

### CROSS-REFERENCE TO RELATED APPLICATION

This application claims priority of Chinese patent Application No. 03202257.3, filed on Jan. 30, 2003.

### BACKGROUND OF THE INVENTION

1. Field of the Invention

This invention relates to an inflatable article, more particularly to an inflatable article for use as a mattress, which includes upper and lower mattress bodies with similar dimension, that are securely superimposed upon each other.

2. Description of the Related Art

Referring to FIGS. 1 and 2, a conventional inflatable mattress 1 is shown to include upper and lower mattress bodies 101,102 which are superimposed upon each other. The upper mattress body 101 is used as a bed body on which the user can arrest, while the lower mattress body 102 is used as a bed frame for supporting the bed body. The method for manufacturing the inflatable mattress 1 includes the step of connecting lower ends 142 of a plurality of bracing strips 14 (PVC material) to a first sheet 11 (PVC material), and connecting upper ends 141 of the bracing strips 14 to a second sheet 12 (PVC material) by using a heat-sealing device (not shown). Then, lower ends 152 of a plurality of bracing strips 15 (PVC material) are connected to the second sheet 12, and upper ends 151 of the bracing strips 15 are connected to a third sheet 13 (PVC material) by heat-sealing. Subsequently, an interconnecting strip 16 (PVC material) is used to interconnect, by heat sealing, peripheries of the first, second and third sheets 11,12,13 and the interconnecting strip 16 so as to form the upper and lower mattress bodies 101,102 with upper and lower air chambers. Two valves 17 are disposed on the upper and lower mattress bodies 101,102 to admit entrance of air into the air chambers.

In use, referring to FIG. 3, due to the combined thickness of the upper and lower mattress bodies 101,102, a standard-size bedcover 2 can only cover the upper mattress body 101, and cannot be tucked under the mattress 1. Thus, referring to FIG. 4, a customized bedcover 2′ of particular size is needed to completely cover the mattress 1 and to be retained at a bottom 162 of the mattress 1.

### SUMMARY OF THE INVENTION

The object of the present invention is to provide a process for manufacturing an inflatable article that can be adapted for use with a standard-size bedcover.

According to a first aspect of this invention, a process for manufacturing an inflatable article comprises the steps of:
i) providing a first lower sheet that is formed from a heat-sealable and flexible material, the first lower sheet including a first central area, a first peripheral area surrounding the first central area, and a first juncture joining the first central and peripheral areas;
ii) providing a plurality of first bracing strips that are formed from a heat-sealable and flexible material, each of the first bracing strips having first upper and lower ends opposite to each other;
iii) connecting the first lower ends to the first central area by heat-sealing such that the first lower ends are displaced from one another in the first central area;
iv) providing a second upper sheet that is formed from a heat-sealable and flexible material, the second upper sheet including a second central area, a second peripheral area surrounding the second central area, and a second juncture joining the second central and peripheral areas;
v) providing a plurality of second bracing strips that are formed from a heat-sealable and flexible material, each of the second bracing strips having second upper and lower ends opposite to each other;
vi) connecting the second upper ends to the second central area by heat-sealing such that the second upper ends are displaced from one another in the second central area;
vii) uniting the first juncture and the second juncture by heat-sealing;
viii) connecting a third central area of a first upper sheet and a fourth central area of a second lower sheet respectively to the first upper ends of the first bracing strips and the second lower ends of the second bracing strips, respectively, by heat-sealing, such that once the first central area and the third central area are pulled away from each other, a plurality of upper air chambers are formed between the first upper and lower sheets by the first bracing strips, and such that once the second central area and the fourth central area are pulled away from each other, a plurality of lower air chambers are formed between the second upper and lower sheets by the second bracing strips; and
ix) using a first interconnecting strip that is formed from a heat-sealable and flexible material to interconnect, by heat sealing, the first peripheral area of the first lower sheet and a third peripheral area of the first upper sheet which surrounds the third central area such that the first interconnecting strip encloses and conceals the upper air chambers; and
x) using a second interconnecting strip that is formed from a heat-sealable and flexible material to interconnect, by heat sealing, the second peripheral area of the second upper sheet and a fourth peripheral area of the second lower sheet which surrounds the second central area such that the second interconnecting strip encloses and conceals the lower air chambers.

According to a second aspect of the invention, an inflatable article is manufactured by the aforesaid process.

According to a third aspect of this invention, a process for manufacturing an inflatable article comprises the steps of:
i) providing a first lower sheet that is formed from a heat-sealable and flexible material, the first lower sheet including a first central area, a first peripheral area surrounding the first central area, and a first juncture joining the first central and peripheral areas;
ii) providing a second upper sheet that is formed from a heat-sealable and flexible material, the second upper sheet including a second central area, a second peripheral area surrounding the second central area, and a second juncture joining the second central and peripheral areas;
iii) uniting the first juncture and the second juncture by heat-sealing;
iv) providing a first interconnecting strip that is formed from a heat-sealable and flexible material and that has first upper and lower strip ends opposite to each other;
v) connecting the first lower strip end of the first interconnecting strip to the first peripheral area of the first lower sheet by heat-sealing such that the first lower strip end surrounds the first central area;
vi) providing a second interconnecting strip that is formed from a heat-sealable and flexible material and that has second upper and lower strip ends opposite to each other;
vii) connecting the second upper strip end of the second interconnecting strip to the second peripheral area of the second upper sheet by heat-sealing such that the second upper strip end surrounds the second central area; and
viii) connecting a third peripheral area of a first upper sheet and a fourth peripheral area of a second lower sheet to the first upper strip end of the first interconnecting strip and the second lower strip end of the second interconnecting strip, respectively, by heat sealing so as to confine upper and lower air chambers, respectively.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a conventional inflatable mattress;

FIG. 2 is a sectional view taken along lines 2-2 in FIG. 1;

FIG. 3 is a perspective view showing the conventional inflatable mattress used with a standard-size bedcover;

FIG. 4 is a perspective view showing the conventional inflatable mattress used with a customized bedcover;

FIG. 5 is a perspective view of the first preferred embodiment of an inflatable article according to this invention;

FIG. 6 is an exploded perspective view of an upper mattress body of the first preferred embodiment;

FIG. 7 is an exploded perspective view of a lower mattress body of the first preferred embodiment;

FIGS. 8 to 10 are sectional views showing the steps of manufacturing the upper and lower mattress bodies;

FIGS. 11 to 13 are sectional views showing the steps of manufacturing the inflatable article;

FIG. 14 is a perspective view showing the first preferred embodiment used with a standard-size bedcover;

FIG. 15 is a longitudinally sectional view of the second preferred embodiment of an inflatable article according to this invention;

FIG. 16 is a longitudinally sectional view of the third preferred embodiment of an inflatable article according to this invention;

FIG. 17 is a longitudinally sectional view of the fourth preferred embodiment of an inflatable article according to this invention; and

FIG. 18 is a longitudinally sectional view of the second preferred embodiment of an inflatable article according to this invention.

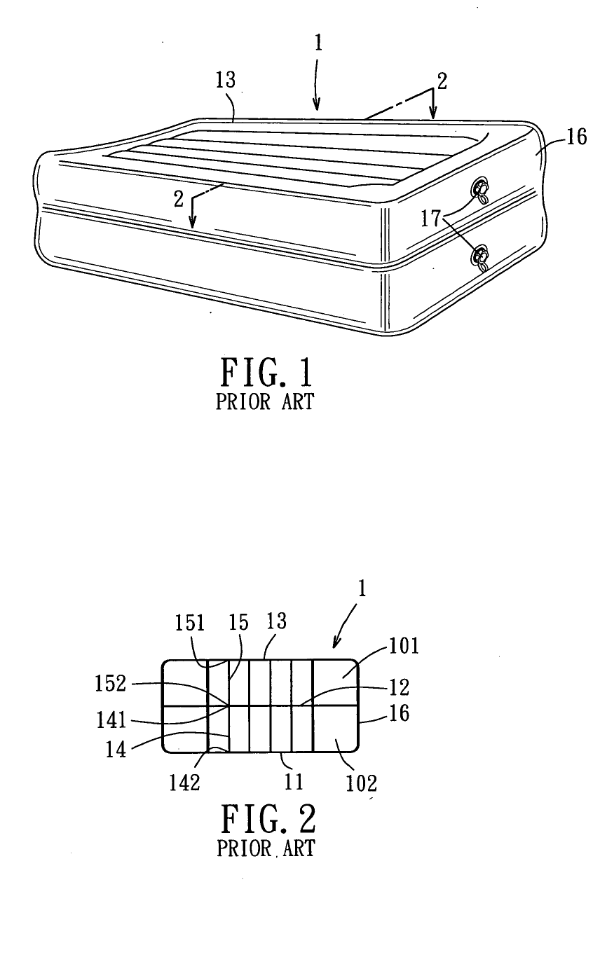

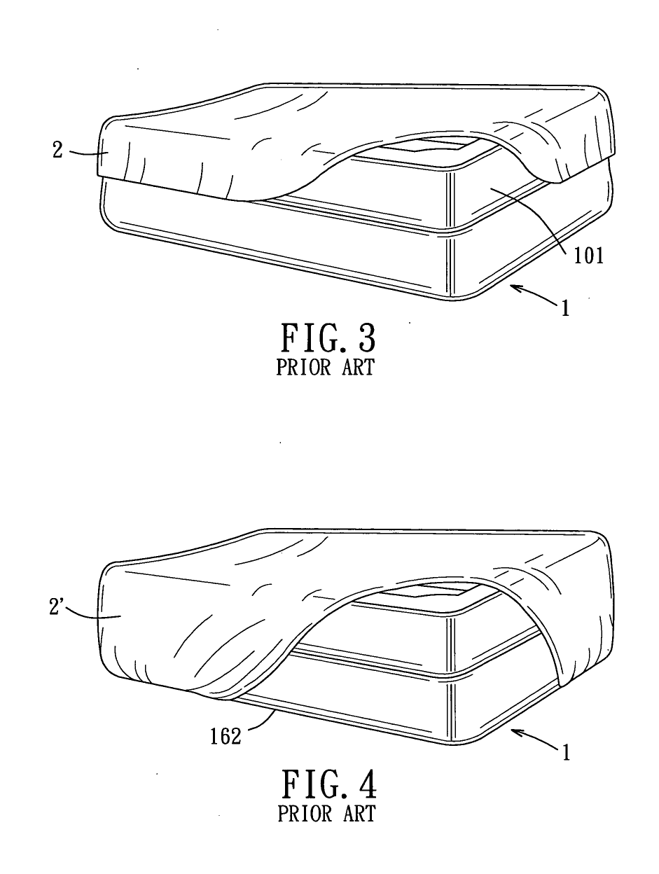

### DETAILED DESCRIPTION OF THE PREFERRED EMBODIMENTS

Before the present invention is described in greater detail, it should be noted that same reference numerals have been used to denote like elements throughout the specification.

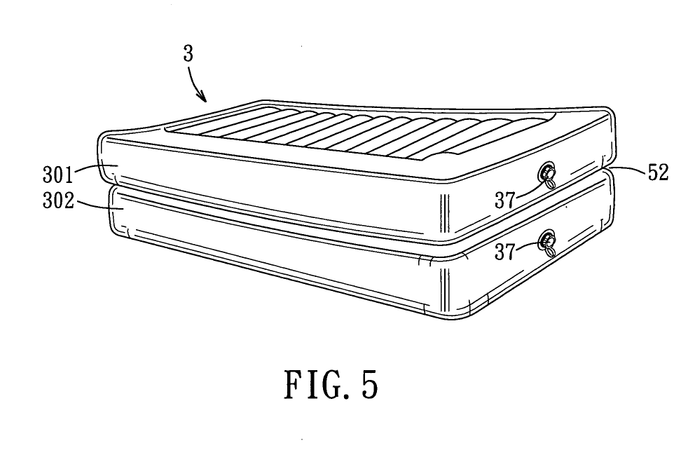

Referring to FIG. 5, the first preferred embodiment of an inflatable article 3 in form of an inflatable mattress according to the present invention is shown to comprise upper and lower mattress bodies 301,302 which are of similar dimensions, and which are securely superimposed upon each other. Each of the upper and lower mattress bodies 301,302 has a box-like shape, and is formed from a heat-sealable and flexible material, such as PVC material or flocking Sumelon material.

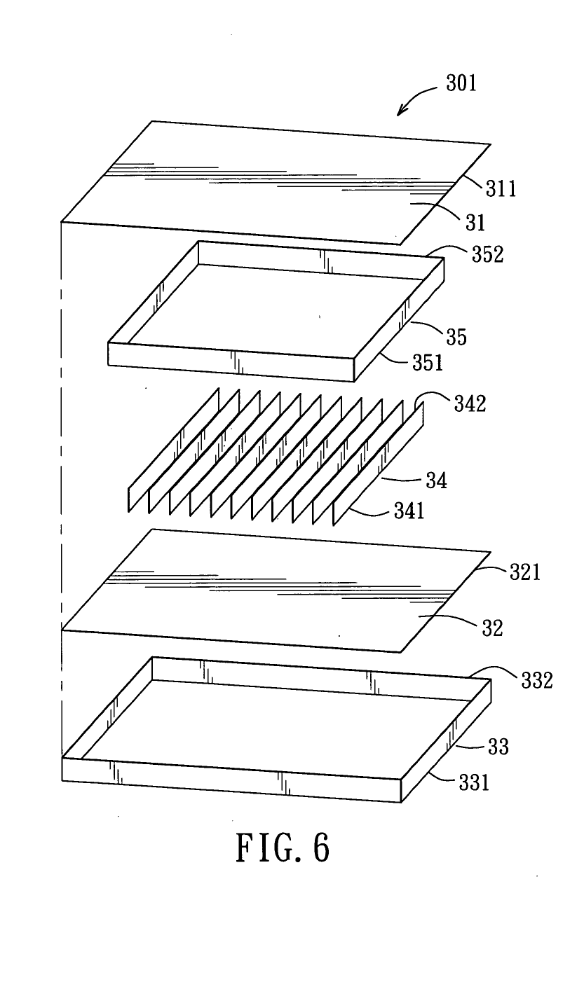

Referring to FIG. 6, the upper mattress body 301 includes first upper and lower sheets 31,32 formed from a heat-sealable and flexible material, and a first interconnecting strip 33 formed from a heat-sealable and flexible material and having opposite upper and lower strip ends 332,331 that are connected to peripheries 311,321 of the first upper and lower sheets 31,32, respectively, to form an upper air chamber. Preferably, a plurality of first bracing strips 34 and a first bracing interconnecting strip 35, which are formed from a heat-sealable and flexible material, are disposed in the upper air chamber to keep the box-like shape of the upper mattress body 301 after inflation. In particular, each of the first bracing strips 34 and the first bracing interconnecting strip 35 has first upper and lower ends 342,341,352,351 which are respectively connected to the first upper and lower sheets 31,32.

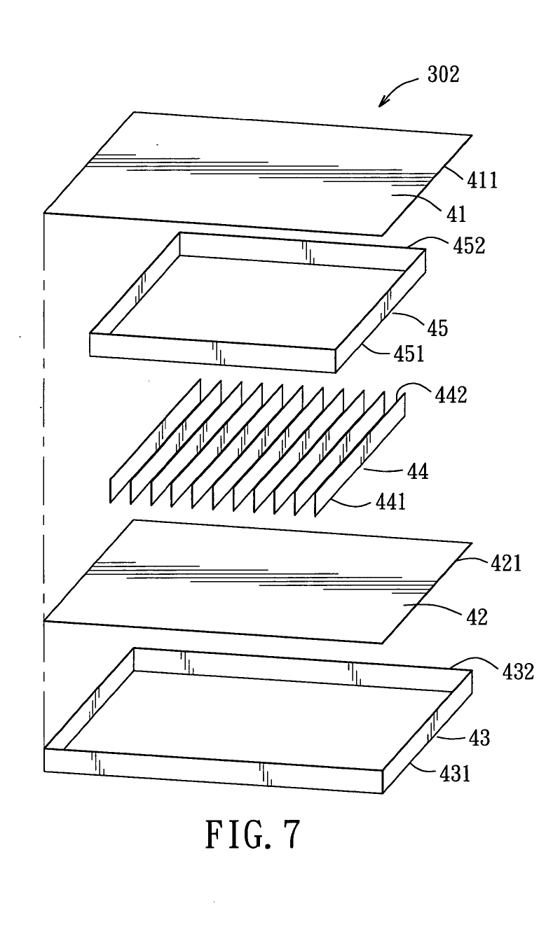

Similarly, referring to FIG. 7, the lower mattress body 302 includes second upper and lower sheets 41,42 formed from a heat-sealable and flexible material, and a first interconnecting strip 43 formed from a heat-sealable and flexible material and having opposite upper and lower strip ends 432,431 that are connected to peripheries 411,421 of the second upper and lower sheets 41,42, respectively, to form a lower air chamber. Preferably, a plurality of second bracing strips 44 and a second bracing interconnecting strip 45, which are formed from a heat-sealable and flexible material, are disposed in the lower air chamber to keep the box-like shape of the lower mattress body 302 after inflation. In particular, each of the second bracing strips 44 and the second bracing inteconnecting strip 45 has second upper and lower ends 442,441,452,451 which are respectively connected to the second upper and lower sheets 41,42.

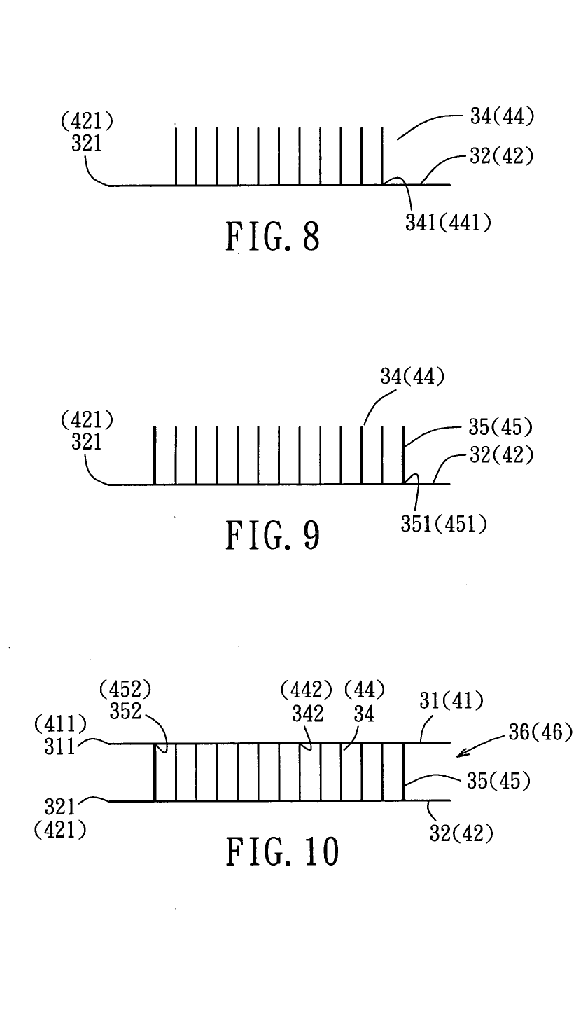

Referring to FIGS. 8 to 10, a preferred embodiment of a process for manufacturing the aforesaid inflatable article is shown to include the step of providing a first lower sheet 32, a plurality of first bracing strips 34 and a first bracing interconnecting strip 35. The first lower sheet 32 includes a first central area, a first peripheral area surrounding the first central area, and a first juncture joining the first central and peripheral areas. Each of the first bracing strips 34 and the first bracing interconnecting strip 35 has first upper and lower ends 342,341,352,351.

The first lower ends 341 of the first bracing strips 34 are connected to the first central area of the first lower sheet 32 by heat-sealing such that the first lower ends 341 are displaced from one another in the first central area, as shown in FIG. 8. In addition, the first lower end 351 of the first bracing interconnecting strip 35 is connected to the first central area of the first lower sheet 32 by heat-sealing such that the first bracing interconnecting strip 35 surrounds the first bracing strips 34, as shown in FIG. 9.

Thereafter, a third central area of a first upper sheet 31 is connected to the first upper ends 342,352 of the first bracing strips 34 and the first bracing interconnecting strip 35 by heat-sealing to form an upper unit 36. As such, once the first central area of the first lower sheet 32 and the third central area of the first upper sheet 31 are pulled away from each other, a plurality of upper air chambers are formed between the first upper and lower sheets 31,32 due to the arrangement of the first bracing strips 34 and the first bracing interconnecting strip 35, as shown in FIG. 10.

The process further includes the step of providing a second lower sheet 42, a plurality of second bracing strips 44 and a second bracing interconnecting strip 45. The second lower sheet 42 includes a fourth central area, a fourth peripheral area surrounding the fourth central area, and a fourth juncture joining the fourth central and peripheral areas. Each of the second bracing strips 44 and the second bracing interconnecting strip 45 includes second upper and lower ends 442,441,452,451.

The second lower ends 441 of the second bracing strips 44 are connected to the fourth central area of the second lower sheet 42 by heat-sealing such that the second lower ends 441 are displaced from one another in the fourth central area, as shown in FIG. 8. Moreover, the second lower end 451 of the second bracing interconnecting strip 45 is connected to the fourth central area of the second lower sheet 42 by heat-sealing such that the second bracing interconnecting strip 45 surrounds the second bracing strips 44, as shown in FIG. 9.

Thereafter, a second central area of a second upper sheet 41 is connected to the second upper ends 442,452 of the second bracing strips 44 and the second bracing interconnecting strip 45 by heat-sealing to form a lower unit 46. As such, once the fourth central area of the second lower sheet 42 and the fourth central area of the second upper sheet 41 are pulled away from each other, a plurality of lower air chambers are formed between the second upper and lower sheets 41,42 due to the arrangement of the second bracing strips 44 and the second bracing interconnecting strip 45, as shown in FIG. 10.

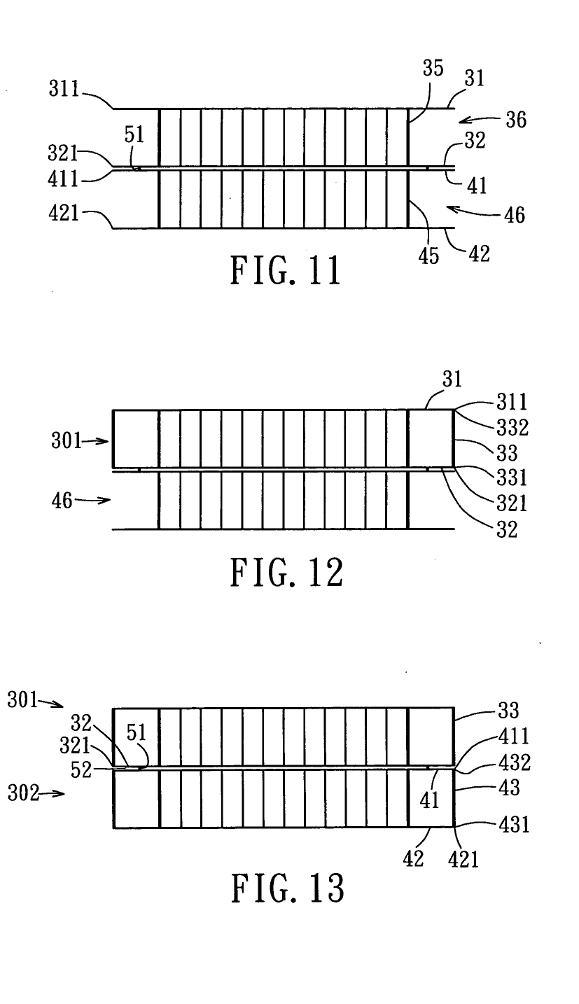

Referring to FIGS. 11 to 13, after the upper and lower units 36,46 are formed, the first juncture of the first lower sheet 32 and the second juncture of the second upper sheet 41 are united at a joint line 51 by heat-sealing, as shown in FIG. 11.

Thereafter, the first peripheral area of the first lower sheet 32 and a third peripheral area of the first upper sheet 31, which surrounds the third central area, are interconnected by using a first interconnecting strip 33. The first interconnecting strip 33 has a valve 37 (see FIG. 5) disposed thereon, and includes lower and upper strip ends 331,332 which are respectively connected to a periphery 321 of the first peripheral area of the first lower sheet 32 and a periphery 311 of the third peripheral area of the first upper sheet 31 by heat-sealing such that the first interconnecting strip 33 encloses and conceals the upper air chambers, as shown in FIG. 12, thereby forming an upper mattress body 301.

At the same time, the second peripheral area of the second upper sheet 41 and a fourth peripheral area of the second lower sheet 42, which surrounds the fourth central area, are interconnected by using a second interconnecting strip 43. The second interconnecting strip 43 has a valve 37 (see FIG. 5) disposed thereon, and includes upper and lower strip ends 432,431 which are respectively connected to a periphery 411 of the second peripheral area of the second upper sheet 41 and a periphery 421 of the fourth peripheral area of the second lower sheet 42 such that the second interconnecting strip 43 encloses and conceals the lower air chambers, as shown in FIG. 13, thereby forming a lower mattress body 302.

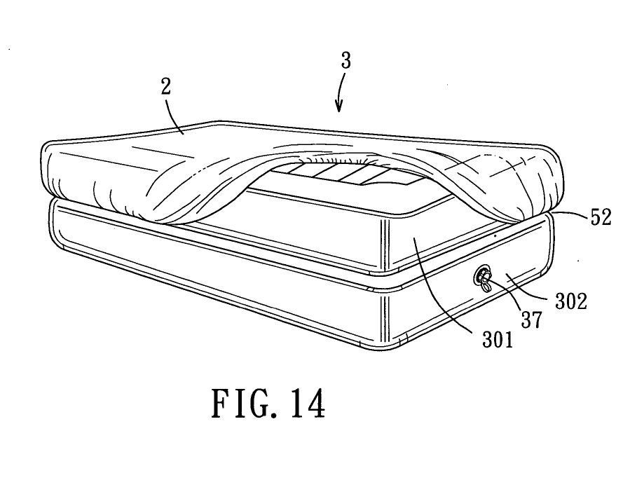

As shown in FIGS. 5 and 13, since the first lower sheet 32 and the second upper sheet 41 are interconnected at the first and second junctures, i.e. at the joint line 51, a surrounding clearance 52 is formed between the upper and lower mattress bodies 301,302 around the joint line 51. Thus, as shown in FIG. 14, when a bedcover 2 of a standard size is used to cover the upper mattress body 301, side edges of the bedcover 2 can be retained in the surrounding clearance 52.

It is noted that during the step of uniting the first juncture and the second juncture, as shown in FIG. 11, since the first upper sheet 31 and the second lower sheet 42 are flexible, the heat-sealing operation is easy to conduct.

It is further noted that the aforesaid steps may not be implemented in the sequence described above. For example, the step of connecting the first upper sheet 31 to the first bracing strip 34 and the first bracing interconnecting strip 35, and the step of connecting the second upper sheet 41 to the second bracing strips 44 and the second bracing interconnecting strip 45 can be implemented after the step of uniting the first juncture and the second juncture. In addition, the step of uniting the first juncture and the second juncture can be implemented before the first and second bracing strips 34,44 and the first and second bracing interconnecting strips 35,45 are respectively connected to the first lower sheet 32 and the second upper sheet 41. Moreover, the second upper sheet 41 may be connected to the second bracing strips 44 and the second bracing interconnecting strip 45 before the second lower sheet 42 is connected to the second bracing strips 44 and the second bracing interconnecting strip 45.

In this embodiment, the heat-sealing process is a high frequency welding process.

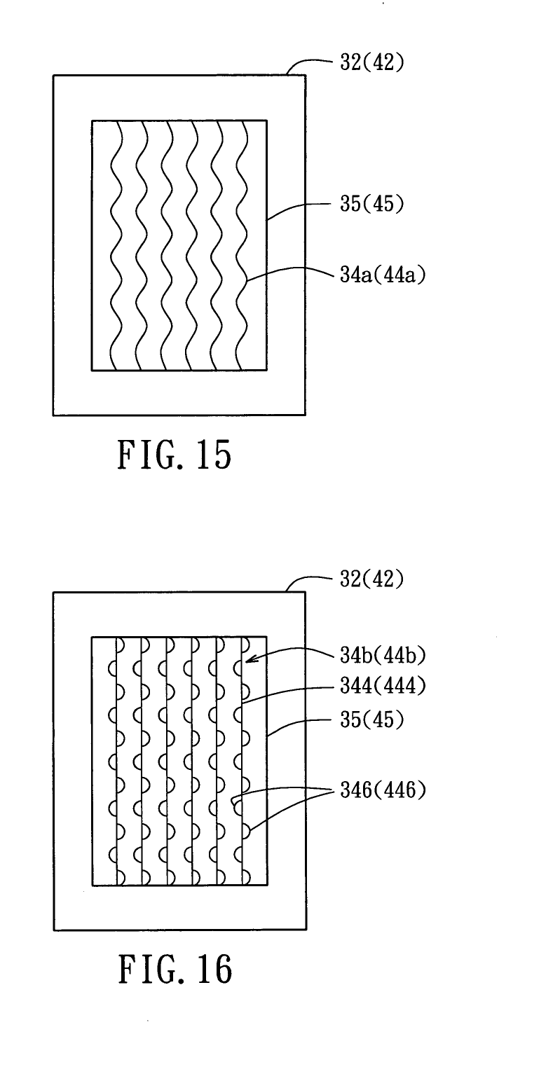

Furthermore, the first and second bracing strips 34,44 are not limited to have the configuration shown in FIGS. 6 and 7. Various forms of the first and second bracing strips can be employed as shown in FIGS. 15 to 18.

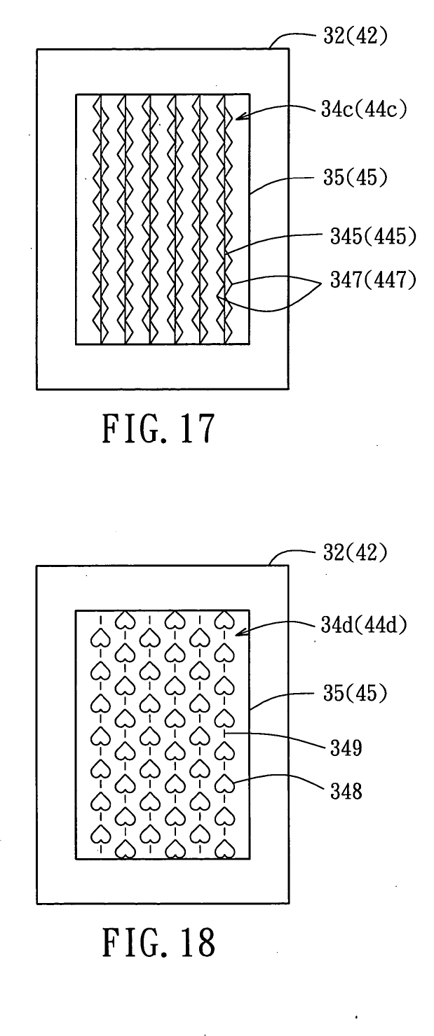

In FIG. 15, each of the first and second bracing strips 34a,44a has a wavy shape. In FIG. 16, each of the first and second bracing strips 34b,44b includes an elongate band 344,444 and a plurality of arcuate pieces 346,446 which are alternately arranged on both sides of the elongate band 344,444 and which are displaced from one another in a lengthwise direction of the elongate band 344,444. In FIG. 17, each of the first and second bracing strips 34c,44c includes an elongate band 345,445 and a plurality of triangular pieces 347,447 which are arranged on both sides of the elongate band 345,445. In FIG. 18, each of the first and second bracing strips 34d,44d includes a plurality of heart-shaped pieces 348 which are arranged in a row, and which are spaced apart from one another by a short piece 349.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A process for manufacturing an inflatable article, comprising the steps of:
i) providing a first lower sheet that is formed from a heat-sealable and flexible material, said first lower sheet including a first central area, a first peripheral area surrounding said first central area, and a first juncture joining said first central and peripheral areas;
ii) providing a plurality of first bracing strips that are formed from a heat-sealable and flexible material, each of said first bracing strips having first upper and lower ends opposite to each other;
iii) connecting said first lower ends to said first central area by heat-sealing such that said first lower ends are displaced from one another in said first central area;
iv) providing a second upper sheet that is formed from a heat-sealable and flexible material, said second upper sheet including a second central area, a second peripheral area surrounding said second central area, and a second juncture joining said second central and peripheral areas;
v) providing a plurality of second bracing strips that are formed from a heat-sealable and flexible material, each of said second bracing strips having second upper and lower ends opposite to each other;
vi) connecting said second upper ends to said second central area by heat-sealing such that said second upper ends are displaced from one another in said second central area;
vii) uniting said first juncture and said second juncture by heat-sealing;
viii) connecting a third central area of a first upper sheet and a fourth central area of a second lower sheet respectively to said first upper ends of said first bracing strips and said second lower ends of said second bracing strips, respectively, by heat-sealing, such that once said first central area and said third central area are pulled away from each other, a plurality of upper air chambers are formed between said first upper and lower sheets by said first bracing strips, and such that once said second central area and said fourth central area are pulled away from each other, a plurality of lower air chambers are formed between said second upper and lower sheets by said second bracing strips; and
ix) using a first interconnecting strip that is formed from a heat-sealable and flexible material to interconnect, by heat sealing, said first peripheral area of said first lower sheet and a third peripheral area of said first upper sheet which surrounds said third central area such that said first interconnecting strip encloses and conceals said upper air chambers; and
x) using a second interconnecting strip that is formed from a heat-sealable and flexible material to interconnect, by heat sealing, said second peripheral area of said second upper sheet and a fourth peripheral area of said second lower sheet which surrounds said second central area such that said second interconnecting strip encloses and conceals said lower air chambers.

2. The process for manufacturing an inflatable article according to claim 1, wherein step viii) is implemented after step vi) and before step vii).

3. The process for manufacturing an inflatable article according to claim 1, wherein step viii) includes the sub-steps of:
viii(a) heat-sealing said third central area to said first upper ends of said first bracing strips; and
viii (b) heat-sealing said fourth central area to said second lower ends of said second bracing strips,
and wherein sub-step viii(a) is implemented after step iii) and before step iv), and sub-step viii(b) is implemented after step vi) and before step vii).

4. An inflatable article manufactured by the process of claim 1.

5. The inflatable article according to claim 4, comprising upper and lower mattress bodies which are of similar dimensions, and which are superimposed upon each other.

6. A process for manufacturing an inflatable article comprising the steps of:
i) providing a first lower sheet that is formed from a heat-sealable and flexible material, said first lower sheet including a first central area, a first peripheral area surrounding said first central area, and a first juncture joining said first central and peripheral areas;
ii) providing a second upper sheet that is formed from a heat-sealable and flexible material, said second upper sheet including a second central area, a second peripheral area surrounding said second central area, and a second juncture joining said second central and peripheral areas;
iii) uniting said first juncture and said second juncture by heat-sealing;
iv) providing a first interconnecting strip that is formed from a heat-sealable and flexible material and that has first upper and lower strip ends opposite to each other;
v) connecting said first lower strip end of said first interconnecting strip to said first peripheral area of said first lower sheet by heat-sealing such that said first lower strip end surrounds said first central area;
vi) providing a second interconnecting strip that is formed from a heat-sealable and flexible material and that has second upper and lower strip ends opposite to each other;
vii) connecting said second upper strip end of said second interconnecting strip to said second peripheral area of said second upper sheet by heat-sealing such that said second upper strip end surrounds said second central area; and
viii) connecting a third peripheral area of a first upper sheet and a fourth peripheral area of a second lower sheet to said first upper strip end of said first interconnecting strip and said second lower strip end of said second interconnecting strip, respectively, by heat sealing so as to confine upper and lower air chambers, respectively.

7. The process for manufacturing an inflatable article according to claim 6, wherein steps iii) to vii) are not implemented in sequence.
